(19) United States
(12) Patent Application Publication
(10) Pub. No.: US 2003/0009353 A1
(43) Pub. Date: Jan. 9, 2003

(54) Data transmission on the basis of a transmission price

(75) Inventor: Jochen Grimminger, Munich (DE)

Correspondence Address: STAAS & HALSEY LLP, 700 11TH STREET, NW, SUITE 500, WASHINGTON, DC, 20001, US

(73) Assignee: Siemens Aktiengesellschaft.

(21) Appl. No.: 10/187,786

(22) Filed: Jul. 3, 2002

(30) Foreign Application Priority Data
Jul. 3, 2001 (DE) 101 32 044.2

(51) Int. Cl. G06F 17/60

(52) U.S. Cl. 705/1

(57) ABSTRACT

Systems, a method and a program product transmit data in which a transmission price is transmitted for the data which are to be transmitted.

### CROSS REFERENCE TO RELATED APPLICATIONS

This application is based on and hereby claims priority to German Application No. 101 32 044.2 filed on Jul. 3, 2001, the contents of which are hereby incorporated by reference.

### BACKGROUND OF THE INVENTION

The invention relates to systems, a method and a computer program for transmitting data.

In future communications networks, there will be the option of determining the type and quality of a communications link. It will likewise be possible to select a very wide variety of telecommunications providers according to various criteria.

From the related art, routers for use with the end customer are known which select the cheapest telephone provider in each case depending on the time and possible duration of a telephone link which is to be set up. For this purpose, the router stores tariff tables which can be updated when required by downloading new tariff tables.

This presents technical problems both for the customer and for the provider. The customer has the problem that he needs to update the tariff data manually either by manual input or by downloading. The user needs to be relieved of this operation by providing him with a suitable technical alternative.

The telecommunications provider has the problem that its networks are not utilized in optimum fashion on account of price information not being up to date or being too general. Unnecessary load peaks arise which necessitate additional hardware investment.

### SUMMARY OF THE INVENTION

Accordingly, a customer system for transmitting data for a customer from and/or to a provider system has a unit to transmit a transmission tender for the respective data which are currently to be transmitted. The transmission tender contains a transmission price.

A provider system for transmitting data for a customer from and/or to a customer system has a unit to transmit a transmission tender for the respective data which are currently to be transmitted. The transmission tender contains a transmission price.

The terms customer system and provider system do not have to involve the customer or provider being the holder or owner of the respective system. Instead, it is adequate for the system to be used for the purposes of the customer or provider.

The customer is a customer for the transmission of data, and the provider is a provider for the transmission of data.

The transmission tender can be transmitted from the customer system to the provider system or from the provider system to the customer system.

Hence, a transmission price is transmitted for the data which are to be transmitted. The transmission of a transmission price for the respective data which are to be transmitted makes pricing much more flexible and up to date both for the customer and for the provider, as a result of which the problems mentioned in the introduction are overcome. In particular, this allows a transmission price to be negotiated or allows transmission services and data which are to be transmitted to be “auctioned”.

To this end, the system has, in particular, a unit to transmit a transmission acceptance which allow a previously received transmission tender to be accepted.

To be able to perform a price comparison, the system can have means for acquiring a plurality of transmission tenders and also a unit to compare the transmission prices associated with these transmission tenders.

Particularly for auctions, it is useful if the system has a unit to calculate a new transmission tender on the basis of a received transmission tender.

The transmission price is set in the system, and, in particular, can be set by the system. The transmission price can be set by the system on the basis of one or more of the following criteria: transmission rate, volume of data, time of transmission, network utilization level and/or transmission path.

The method for transmitting data between a customer system and a provider system is carried out such that at least one of the systems transmits to the other system a transmission tender for the respective data which are to be transmitted, the transmission tender containing a transmission price.

Preferably, this method is continued such that the transmission tender is accepted by the other system if the tendered transmission price is below a prescribed limit value.

Alternatively or in addition, the tendered transmission price can be compared with transmission prices from other providers or customers.

The transmission price is set by at least one of the systems on the basis of one or more of the following criteria: transmission rate, volume of data, time of transmission, network utilization level and/or transmission path.

A computer program for a data processing installation which contains software code sections which can be used to carry out one of the outlined methods on the data processing installation can be executed by suitable implementation of the method in a programming language and translation into code which can be executed by the data processing installation. To this end, the software code sections are stored. In this case, a computer program is understood to mean the program as a tradable product. It can be in any form, for example distributed on paper, on a computer-readable data medium or over a network.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a provider system and a customer system.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

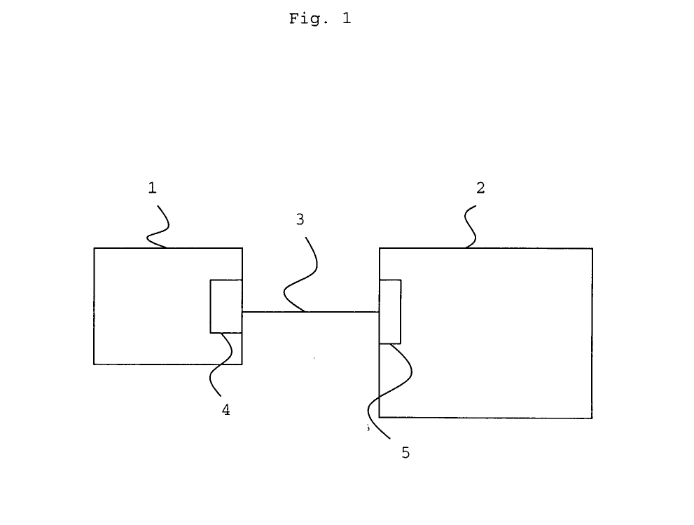

FIG. 1 shows a customer system 1 and a provider system 2. The customer system 1 is connected to the provider system 2 via a data transmission link 3. The data transmission link 3 can be a copper and/or glass-fiber cable and/or also an infrared and/or radio transmission link.

The customer system has a unit 4 to transmit a transmission tender for the respective data which are to be transmitted, the transmission tender containing a transmission price. The transmission price is a transmission price for the data which are to be transmitted. It is a financial burden and not, for example, the price in a cost function, such as is used by different transmission algorithms in order to optimize the transmission performance.

The provider system 2 likewise has a unit 5 to transmit a transmission tender for the respective data which are to be transmitted, the transmission tender containing a transmission price. The units 4, 5 to transmit a transmission tender are simultaneously units to transmit a transmission acceptance, units to acquire a plurality of transmission tenders, units to compare the transmission prices associated with the transmission tenders and units to calculate a new transmission tender on the basis of a received transmission tender. The units 4, 5 to transmit a transmission tender can be in the form of a processor in conjunction with a memory.

The systems also include permanent to removable storage, such as magnetic and optical discs, RAM, ROM, etc. on which the process and data structures of the present invention can be stored and distributed. The processes can also be distributed via, for example, downloading over a network such as the internet.

The memory stores the transmission price, which is set by the respective system 1, 2 on the basis of one or more of the following criteria: transmission rate, volume of data, time of transmission, network utilization level and/or transmission path.

A method for data transmission of data between the customer system and the provider system 2 involves at least one of the systems 1, 2 transmitting to the other system 2, 1 a transmission tender for the respective data which are to be transmitted. The transmission tender contains a transmission price.

A common feature of all the embodiments is that, in the communication between customer system and provider system, price information is additionally transmitted which contains a transmission price which is acceptable to the customer or the provider for a link having the respectively indicated characteristics. The respective other system can then either accept, reject or can present a separate transmission tender. Negotiations take place and there is possibly an auction. The customer is thus able to communicate very cheaply, and the provider can attempt to utilize his network as optimally as possible and to weigh costs and receipts against one another more precisely.

One aspect of the invention involves developing communication or transmission between the customer system and the provider system, as a result of which it is possible to use dynamic price models which allow additional criteria, such as transmission rate, volume of data, time of transmission, network utilization level and/or transmission path, to be included in pricing as well.

The customer system can, in particular, also be in the form of a terminal in the form of a mobile communications unit (mobile telephone, personal organizer, smart phone, portable computer) or a PC. The provider system can, in particular, comprise a network.

The invention has been described in detail with particular reference to preferred embodiments thereof and examples, but it will be understood that variations and modifications can be effected within the spirit and scope of the invention.

What is claimed is:

1. A customer system for communicating data with a provider arrangement, for a customer, comprising:
a unit to transmit a transmission tender for the respective data which are to be communicated, the transmission tender containing a transmission price.

2. The customer arrangement as claimed in claim 1, further comprising a unit to transmit a transmission acceptance.

3. The customer arrangement as claimed in claim 1, further comprising:
a unit to acquire a plurality of transmission tenders; and
a unit to compare the transmission prices associated with the transmission tenders.

4. The customer arrangement as claimed in claim 1, further comprising a unit to calculate a new transmission tender based on a received transmission tender.

5. The customer arrangement as claimed in claim 1,
wherein the transmission price is set based on at least one criteria selected from the group consisting of transmission rate, volume of data, time of transmission, network utilization level and transmission path.

6. The customer arrangement as claimed in claim 2, further comprising:
a unit to acquire a plurality of transmission tenders; and
a unit to compare the transmission prices associated with the transmission tenders.

7. The customer arrangement as claimed in claim 6, further comprising a unit to calculate a new transmission tender based on a received transmission tender.

8. The customer arrangement as claimed in claim 7,
wherein the transmission price is set based on at least one criteria selected from the group consisting of transmission rate, volume of data, time of transmission, network utilization level and transmission path.

9. The customer system as claimed in claim 1, wherein the data is transmitted from the provider system to the customer system and from the customer system to the provider system.

10. A provider system for communicating data with a customer arrangement, for a customer, comprising:
a unit to transmit a transmission tender for the respective data which are to be communicated, the transmission tender containing a transmission price.

11. The customer arrangement as claimed in claim 10, further comprising a unit to transmit a transmission acceptance.

12. The customer arrangement as claimed in claim 10, further comprising:
a unit to acquire a plurality of transmission tenders; and
a unit to compare the transmission prices associated with the transmission tenders.

13. The customer arrangement as claimed in claim 10, further comprising a unit to calculate a new transmission tender based on a received transmission tender.

14. The customer arrangement as claimed in claim 10,
wherein the transmission price is set based on at least one criteria selected from the group consisting of transmission rate, volume of data, time of transmission, network utilization level and transmission path.

15. The customer arrangement as claimed in claim 11, further comprising:
a unit to acquire a plurality of transmission tenders; and
a unit to compare the transmission prices associated with the transmission tenders.

16. The customer arrangement as claimed in claim 15, further comprising a unit to calculate a new transmission tender based on a received transmission tender.

17. The customer arrangement as claimed in claim 16,
wherein the transmission price is set based on at least one criteria selected from the group consisting of transmission rate, volume of data, time of transmission, network utilization level and transmission path.

18. The customer system as claimed in claim 10, wherein the data is transmitted from the provider system to the customer system and from the customer system to the provider system.

19. A method for communicating data between a customer and a provider, comprising:
transmitting a transmission tender for the respective data which are to be communicated, the tender containing a transmission price, the tender being transmitted from one of the customer and the provider to the other of the customer and the provider.

20. The method as claimed in claim 19, further comprising accepting the transmission tender if the tendered transmission price is below a prescribed limit value.

21. The method as claimed in claim 19, further comprising comparing the transmission price received in the transmission tender with transmission prices from other providers or customers.

22. The method as claimed in claim 19, wherein the transmission price is set based on at least one criteria selected from the group consisting of transmission rate, volume of data, time of transmission, network utilization level and/or transmission path.

23. A computer readable medium storing a program for controlling a computer to perform a method comprising: transmitting a transmission tender for the respective data which are to be communicated, the tender containing a transmission price, the tender being transmitted from one of the customer and the provider to the other of the customer and the provider.

24. A computer readable medium according to claim 23, wherein the method further comprises accepting the transmission tender if the tendered transmission price is below a prescribed limit value.

25. A computer readable medium according to claim 23, wherein the method further comprises comparing the transmission price received in the transmission tender with transmission prices from other providers or customers.

26. A computer readable medium according to claim 23, wherein for the method, the transmission price is set based on at least one criteria selected from the group consisting of transmission rate, volume of data, time of transmission, network utilization level and/or transmission path.
